(19) United States
(12) Patent Application Publication
(10) Pub. No.: US 2023/0386731 A1
(43) Pub. Date: Nov. 30, 2023

(54) TRANSFORMER WITH BOTTOM COIL SHIELDING FOR IMPROVED EMI AND THERMAL CHARACTERISTICS

(71) Applicant: TEXAS INSTRUMENTS INCORPORATED, Dallas, TX (US)

(72) Inventors: Nicola BERTONI, Freising (DE); Raul BLECIC, Freising (DE); Dongbin HOU, Plano, TX (US)

(21) Appl. No.: 17/829,073

(22) Filed: May 31, 2022

(51) Int. Cl. H01F 27/28

(52) U.S. Cl. CPC H01F 27/2885; H01F 27/2876

(57) ABSTRACT

An apparatus includes a substrate and first through fourth conductive layers. The first conductive layer is on the substrate and includes a first electromagnetic interference (EMI) shield. The second conductive layer is over the first conductive layer opposite the substrate and includes a first winding of a transformer. The third conductive layer is over the second conductive layer opposite the first conductive layer and includes a second EMI shield. The fourth conductive layer is over the third conductive layer opposite the second conductive layer and includes a second winding of the transformer.

### BACKGROUND

A transformer generally includes two conductive windings (also referred to as coils or inductors)—a “primary” winding and a “secondary” winding. Many types of circuits include transformers. For example, an isolation voltage converter converts an input direct current (DC) voltage to a different, output DC voltage using a transformer. A conventional isolation voltage converter is a package having an isolation transformer coupled to two separate dies by way of bond wires. One die includes a circuit coupled to the primary winding of the transformer and includes a switching network to convert the DC input voltage to a switching waveform to transfer energy through from the primary winding to the secondary winding of the transformer. The die coupled to the secondary winding includes a rectifier to convert the switching waveform from the secondary winding to a DC output voltage. In some isolation transformers, the transformer may be the largest source of heat generation.

### SUMMARY

In one example, an apparatus includes a substrate and first through fourth conductive layers. The first conductive layer is on the substrate and includes a first electromagnetic interference (EMI) shield. The second conductive layer is over the first conductive layer opposite the substrate and includes a first winding of a transformer. The third conductive layer is over the second conductive layer opposite the first conductive layer and includes a second EMI shield. The fourth conductive layer is over the third conductive layer opposite the second conductive layer and includes a second winding of the transformer.

### BRIEF DESCRIPTION OF THE DRAWINGS

FIG. 1 is a circuit schematic of an isolated voltage converter including a transformer, in accordance with an example.

FIG. 2 is a circuit schematic of a primary-side power stage for use in the isolated voltage converter of FIG. 1, in accordance with an example.

FIGS. 3-6 are three-dimensional views of an example transformer usable in the isolated voltage converter of FIG. 1.

FIGS. 7-9 are three-dimensional views of another example transformer usable in the isolated voltage converter of FIG. 1.

### DETAILED DESCRIPTION

The same reference numbers or other reference designators are used in the drawings to designate the same or similar (either by function and/or structure) features.

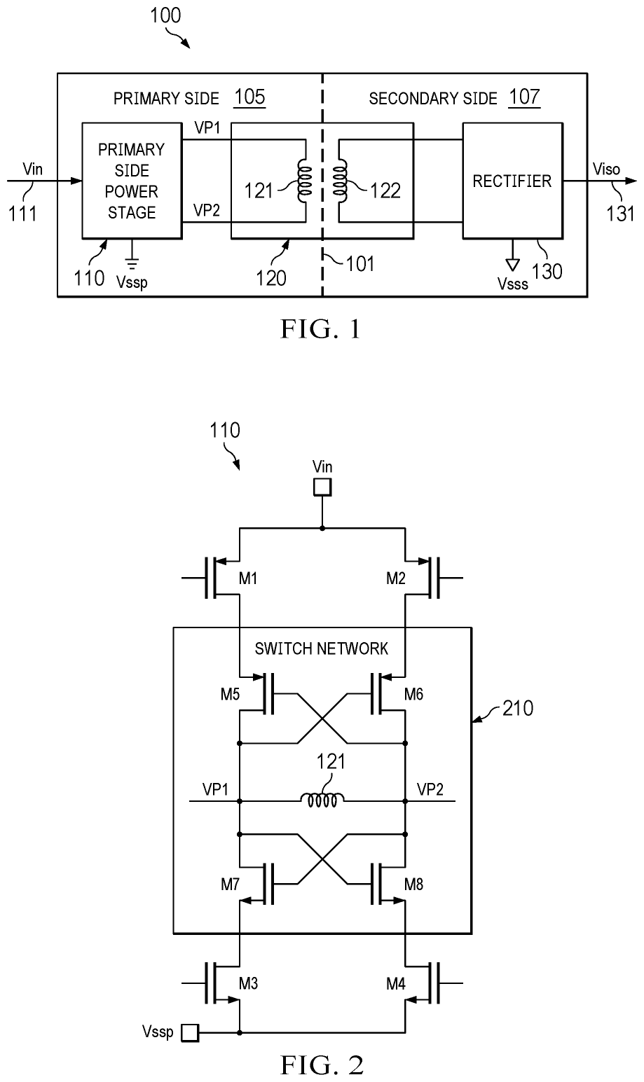

FIG. 1 is a block diagram of an isolation voltage converter 100 in accordance with an example embodiment. The isolation voltage converter 100 has a primary side 105 and a secondary side 107. The isolated voltage converter 100 includes a transformer 120 that is operable as an isolation transformer to galvanically isolate the primary side 105 from the secondary side 107. The dashed line 101 delineates the primary side 105 from the secondary side 107. No electrical connection is present between the primary and secondary sides. The terms “primary” and “secondary” refer to the primary and secondary inductors (also referred to as coils or windings) of the transformer 120.

The primary side 105 includes a voltage input 111. The DC input voltage provided to the voltage input 111 is labeled Vin. The secondary side 107 includes a voltage output 131. The isolated output voltage from the voltage output 131 is Viso. The primary side 105 includes a primary-side power stage 110. The secondary side 107 includes a rectifier 130. In one example, the rectifier 130 is a full-bridge rectifier comprising four diodes, although other implementations of the rectifier are possible as well. The primary side 105 has a ground Vssp. The secondary side 107 has a ground Vsss. The grounds Vssp and Vsss are isolated from each other.

The transformer 120 has a primary winding 121 and a secondary winding 122. The primary-side power stage 110 receives Vin, and switch nodes VP1 and VP2 of the primary-side power are coupled to the terminals of the primary winding 121 of the transformer 120 as shown. The rectifier 130 is coupled to the secondary winding 122 of the transformer 120. The rectifier 130 converts the time-varying voltage from the secondary winding 122 of the transformer to the DC output voltage Viso. The voltages Vin and Viso do not share the same ground and are galvanically isolated from each other.

In one example, the primary-side power stage 110 is provided on a first semiconductor die, and the rectifier 130 is provided on a second semiconductor die. The first and second semiconductor dies are coupled to the respective windings 121 and 122 of the transformer 120. Mold compound may be included to encapsulate and protect both dies and the transformer to provide the isolation voltage converter as a single packaged apparatus.

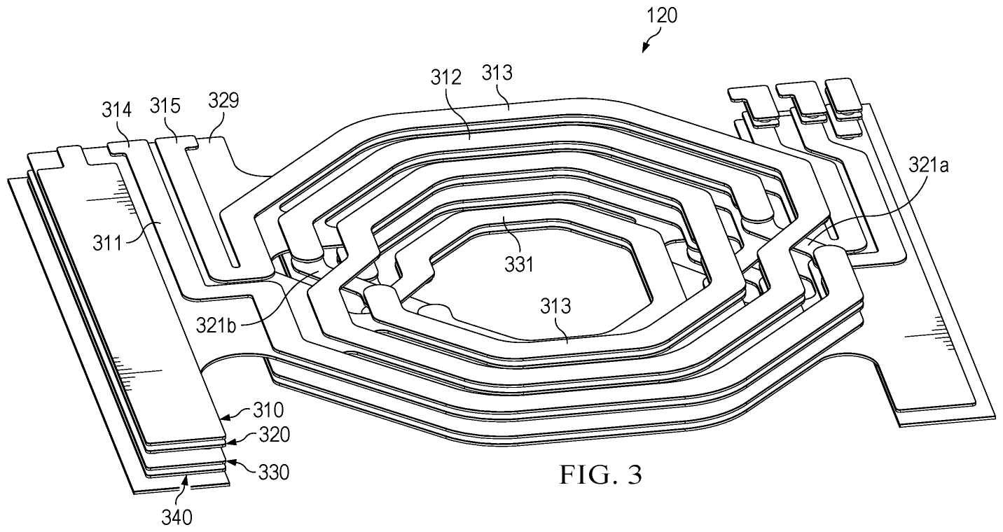

Numerous implementations are possible for the primary-side power stage 110 and within the scope of this disclosure. FIG. 2 is a schematic diagram illustrating one example implementation of the primary-side power stage 110. In this example, the primary-side power stage 110 includes transistors M1-M4 and a switch network 210. The switch network 210 includes two pairs of cross-coupled transistors. One pair of cross-coupled transistors includes transistors M5 and M6 and the other pair of cross-coupled transistors includes transistors M7 and M8. Transistors M1, M2, M5, and M6 are P-channel field effect transistors (PFETs), and transistors M3, M4, M7, and M8 are N-channel field-effect transistors (NFETs). The sources of transistors M1 and M2 are coupled together and receive Vin. The sources of transistors M3 and M4 are coupled together at ground Vssp. The drain of transistor M1 is coupled to the source of transistor M5, and the drain of transistor M2 is coupled to the source of transistor M6. The gate of transistor M5 is coupled to the drain of transistor M6, and the gate of transistor M6 is coupled to the drain of M5.

The drains of M5 and M7 are coupled together at the switch node VP1, and the drains of M6 and M8 are coupled together at the switch node VP2. The gate of M7 is coupled to the drain of M8, and the gate of M8 is coupled to the drain of M7. The source of M7 is coupled to the drain of M3, and the source of M8 is coupled to the drain of M4. The terminals of the primary winding 121 of the transformer 120 are coupled to the switch nodes VP1 and VP2.

In one embodiment, transistors M1, M2, M3, and M4 are lower voltage-rated transistors than transistors M5, M6, M7, and M8. The voltage rating of the transistor refers to the maximum allowed drain-to source voltage (Vds) and the maximum allowed gate-to-source voltage (Vgs). A lower voltage rated transistor has a better Figure of Merit (FoM) in terms of the product of the on-resistance and the gate charge (Rdson*Qg), which means that lower voltage-rated transistors produce lower loss when switching at a higher frequency compared to a transistor rated for higher voltages. In one specific example, each of transistors M5-M8 are 5V transistors (maximum allowed Vds or Vgs is 5V), and transistors M1-M4 are 1.5V transistors (maximum allowed Vds or Vgs is 1.5V).

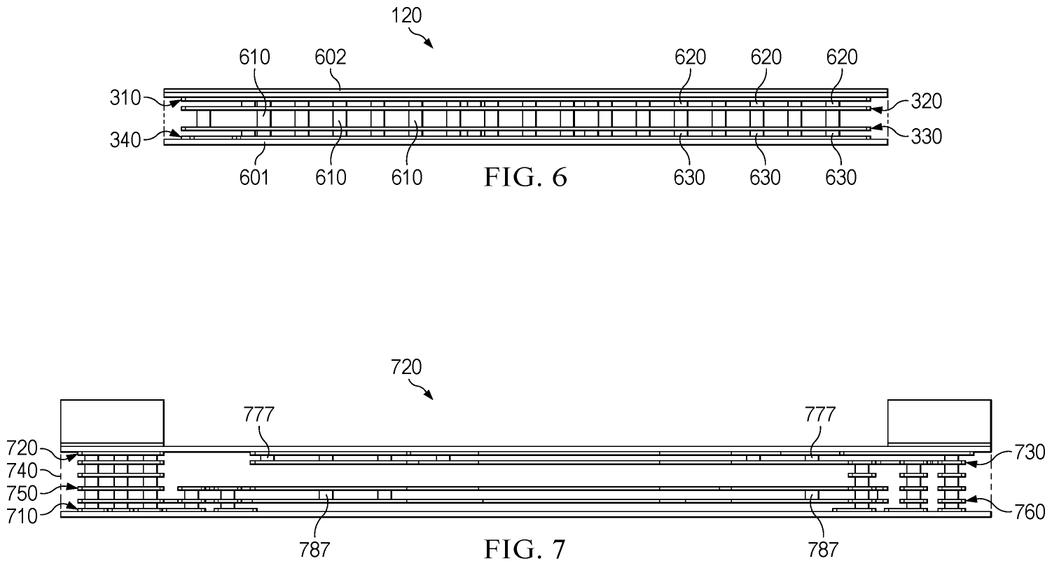

Transistors M1, M2, M3, and M4 are actively driven through the use of control signals described below with reference to FIG. 6. During operation, the control signals are asserted in a manner to cause transistors M2 and M3 to be on concurrently, while transistors M1 and M4 are off, and then to cause transistors M1 and M4 to be on, while transistors M2 and M3 off. The on and off states of transistors M1-M4 repeats—transistors M1 and M4 on (transistors M2 and M3 off), then transistors M2 and M3 on (transistors M1 and M4 off), then transistors M1 and M4 on again (transistors M2 and M3 off), and so on.

The on and off states of the cross-coupled transistors M5/M6 and M7/M8 are controlled as a result of the on/off states of transistors M1-M4. That is, transistors M5-M8 are not actively driven by independently supplied control signals as otherwise is the case for transistors M1-M4. For example, with transistors M2 and M3 on (and transistors M1 and M4 off), transistors M6 and M7 also are on (and transistors M5 and M6 are off). In this portion of each switching cycle, of the eight transistors, transistors M2, M6, M7, and M3 are on and the remaining transistors are off. With transistors M2 and M6 on, switch node VP2 is pulled high towards Vin, and with transistors M3 and M7 on, switch node VP1 is pulled low towards Vssp. In the opposite state of the switching cycle (transistors M1, M5, M8, and M4 on, and M2, M6, M7, and M3 off), switch node VP1 is pulled high towards Vin and switch node VP2 is pulled low towards Vssp.

FIGS. 3, 4, and 5 show views of the transformer 120 in accordance with one embodiment. The illustrative transformer 120 includes two Faraday shields that also function as heat dissipation elements for the transformer. In this context, each Faraday shield is a conductive structure that provides a current path to ground for common mode current thereby reducing the generation of electromagnetic interference (EMI). Ideally, when a transformer is differentially driven and its structure is perfectly symmetrical, primary winding current will flow to the primary-side ground and no current capacitively. In practice, however, due to asymmetries in both the driver/rectifier and the transformer, a common mode current flows from the primary side of the transformer to the secondary side. The common mode current may flow through the parasitic capacitance between the transformer and the printed circuit board (PCB) on which the transformer is mounted and the primary-side and secondary-side ground planes, which act as a dipole antenna thereby generating EMI. The Faraday shield advantageously provides a lower impedance path for the common mode current to ground instead of crossing the barrier. A Faraday shield may also reduce the susceptibility of the transformer from receiving externally-generated EMI. Accordingly, each Faraday shield provides two benefits—(1) EMI reduction and (2) thermal load shedding.

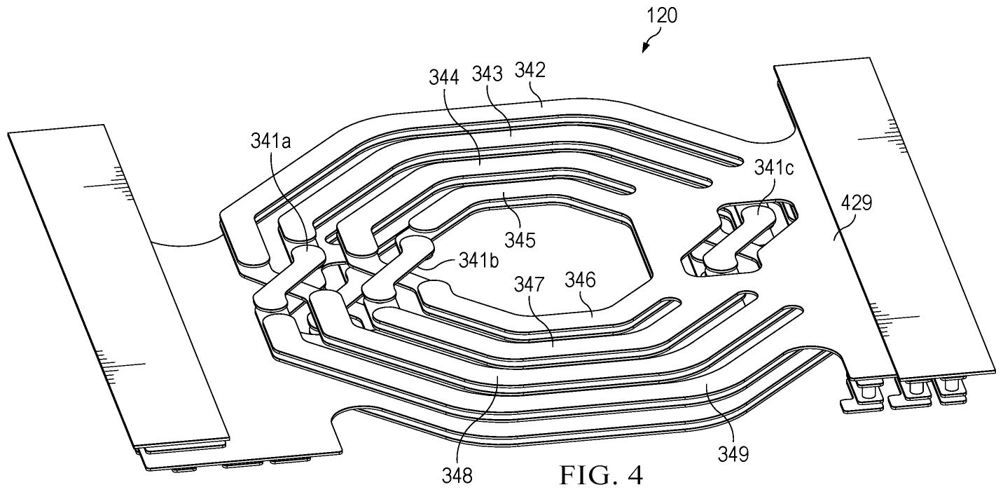

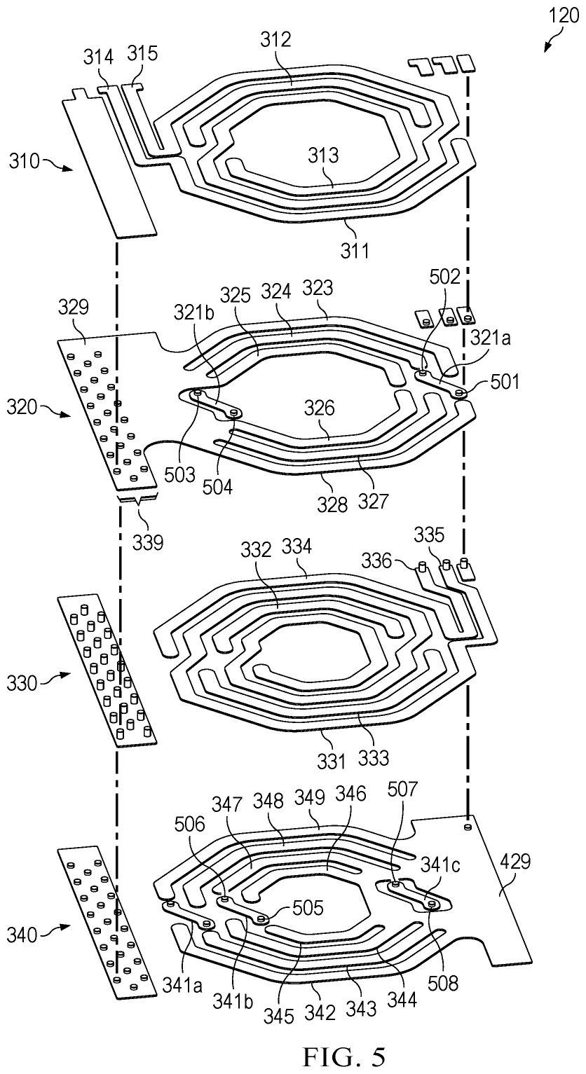

In the example of FIGS. 3-5, the transformer 120 is fabricated as a four-layer structure on a substrate. The four layers include layers 310, 320, 330, and 340. FIG. 3 is a perspective view of the transformer with layer 310 on top and layer 340 on the bottom. FIG. 4 is a perspective of the transformer with the transformer inverted relative to FIG. 3—layer 340 is on top and layer 310 is on the bottom in this view. FIG. 5 is an exploded view of the transformer 120 illustrating each of the layers 310, 320, 330, and 340 in isolation. The following description is provided in relation to FIGS. 3-5 with parenthetical figure references which indicate the best figure to identify a certain feature. In one example, each of the layers 310-340 is an electrically conductive layer fabricated from a metal or other suitable material. A dielectric material (e.g., silicon dioxide) separates the layers 310-340 and prevents one layer 310-340 from electrically shorting to another layer.

Layer 310 includes multiple conductive segments 311, 312, and 313. The conductive segments 311-313 of layer 310 form most of one of the transformer's windings. The ends 314 and 315 of conductive elements 311 and 313, respectively, are the terminals of the winding. Starting from terminal 314, conductive element 311 wraps around part of the periphery of the transformer and then couples to conductive element 321a (FIG. 5) in layer 320 by way of a via 501. Although in layer 320, conductive element 321a is part of the same winding as conductive element 311. The opposite end of conductive element 321 includes another via 502 which couples conductive element 321a to conductive element 312 in layer 310. Conductive element 321a is in layer 320 and functions to electrically couple conductive elements 311 and 312 of layer 310. Accordingly, conductive element 321 is referred to herein as a “bridge.” FIG. 3-5 illustrate additional bridges 321b, 341a, 341b, and 341c, which are described below as well.

Conductive element 312 then extends partially around the transformer 120 as shown and couples to conductive element 313 through vias 503 and 504 and bridge 321b (best shown in FIG. 5). Conductive element 313 wraps approximately twice around the transformer terminating in terminal 315. The winding with terminals 314 and 315 has approximately three turns.

The other winding is predominantly in layer 330 and includes bridges 341a, 341, and 341c in layer 340 (FIG. 5). This particular winding includes conductive elements 331, 332, 333, and 334 with conductive element 331 having a terminal 335 and conductive element 334 having a terminal 336. Terminals 335 and 336 are on an opposite side of the transformer as terminals 314 and 315 of the other winding. As best shown in FIG. 5, starting at terminal 335, conductive element 331 wraps approximately two-and-a-half times around the transformer and electrically couples to conductive element 332 by way of vias 505 and 506 and bridge 341b (in layer 340).

Conductive element 332 extends approximately half-way (180 degrees) around the transformer and couples to conductive element 333 by way of vias 507 and 508 and bridge 341c (in layer 340). Conductive element 333 extends approximately half-way (180 degrees) around the transformer and couples to conductive element 334 by way of vias 509 and 510 and bridge 341a (in layer 340). Conductive element 334 then extends approximately half-way around the transformer and ends at terminal 336. The winding including conductive elements 331-334 is a four-turn winding.

Layer 320 includes bridges 321a and 321b to complete the winding having terminals 314 and 315. Layer 320 also functions as a heat sink for the conductive segments of layer 310. Layer 320 includes a conductive pad 329 from which conductive segments 323, 324, 325, 326, 327, and 328 extend towards the opposite side of the transformer near bridge 321a. Conductive segments 323-328 are connected together through conductive pad 329. In one embodiment, conductive pad 329 is coupled to a common potential (e.g., ground). Conductive pad 329 and conductive segments 323-328 thus form one continuous conductive element which is operative to conduct to ground common mode current that may be caused by the winding formed predominantly by the conductive segments 311-313 of layer 310. Layer 320 thus functions as a Faraday shield for the winding formed predominantly in layer 310.

Additionally, layer 320 is close enough (e.g., within 35 microns) of layer 310 that at least some of the heat load generated by the conductive segments of layer 310 is carried away from the transformer by way of layer 320. Layer 320 is coupled to a leadframe via a die attach pad (DAP) 339. The DAP 339 is grounded and connected to the PCB through the package leads. Heat generated by the layer 310 flows through the dielectric material to layer 320 and then from layer 320 to the leadframe.

Layer 340 includes bridges 341a, 341b, and 341c to complete the winding having terminals 335 and 336. Layer 340 also functions as a heat sink for the conductive segments of layer 330. Layer 340 includes a conductive pad 429 from which conductive segments 342, 343, 344, 345, 346, 347, 348, and 349 extend towards the opposite side of the transformer near bridge 341a. Conductive segments 342-349 are connected together through conductive pad 429. Conductive pad 329 may be coupled to a common potential (e.g., ground). Conductive pad 429 and conductive segments 342-349 thus form one continuous conductive element which is operative to conduct to ground common mode current that may be caused by the winding formed predominantly by the conductive segments 331-334 of layer 330. Layer 340 thus also functions as a Faraday shield for the winding formed predominantly in layer 330. Additionally, layer 340 is close enough (e.g., within 35 microns) of layer 330 that at least some of the heat load generated by the conductive segments of layer 330 is carried away from the transformed by way of layer 340.

FIG. 6 is a side view of transformer 120 illustrating layers 310, 320, 330, and 340. FIG. 6 includes vias 610 that electrically couple together layers 320 and 340, including vias within the DAP 339. Vias 620 and 630 interconnect the bridges of the windings as explained above and include vias within the DAP 339 as well. FIG. 6 further illustrates a substrate 601 on which the transformer structure is formed. In one embodiment, the structure of the transformer 120 is formed one layer at a time interspersed with dielectric material. Photolithography and/or other techniques may be employed to pattern the conductive segments shown in FIGS. 3-5. Dielectric material may be provided between the layers 310, 320, 3330, and 340 and between the patterned conductive segments within any given layer.

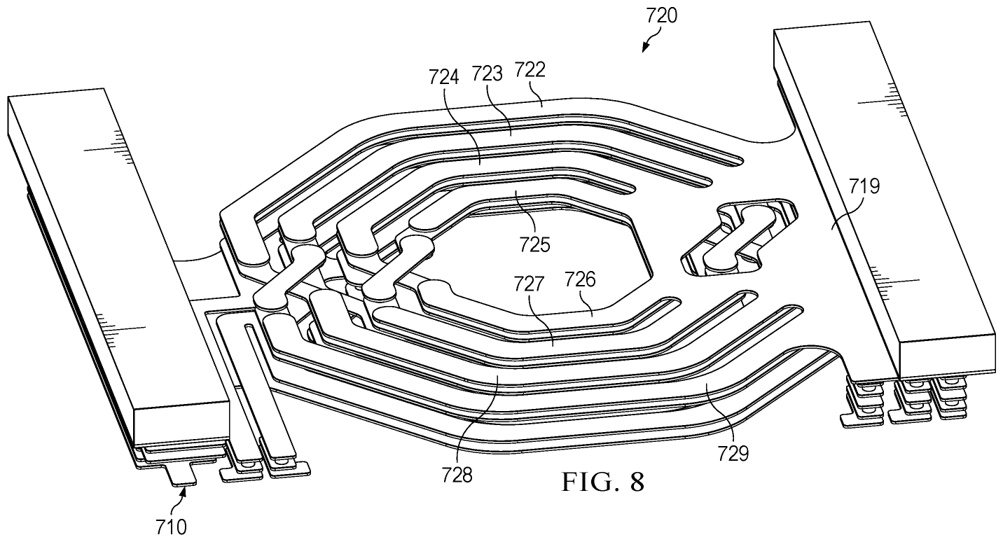

FIGS. 7-9 illustrate another embodiment of a transformer 720. Transformer 720 can be used as transformer 120 in FIG. 1, and thus transformer 720 can be connected to the primary side 105 and the secondary side 107 as shown in FIG. 1. Illustrative transformer 720 is a six-layer structure including layers 710, 720, 730, 740, 750, and 760 formed of metal or other suitable conductive material. Layers 720 and 760 that function as both Faraday shields and as heat sinks for layers 730 and 750. Layer 730 includes conductive segments forming most of one winding, and layer 750 includes conductive segments forming most of another winding of the transformer. Layer 720 is the Faraday shield and heat sink for layer 730, and layer 760 is the Faraday shield and heat sink for layer 750. Layer 740 is a thick dielectric layer (e.g., 35 microns thick) that provides an isolation barrier between layers 730 and 750. Layer 710 is an interconnect layer that connects the terminals of the transformer to external circuitry.

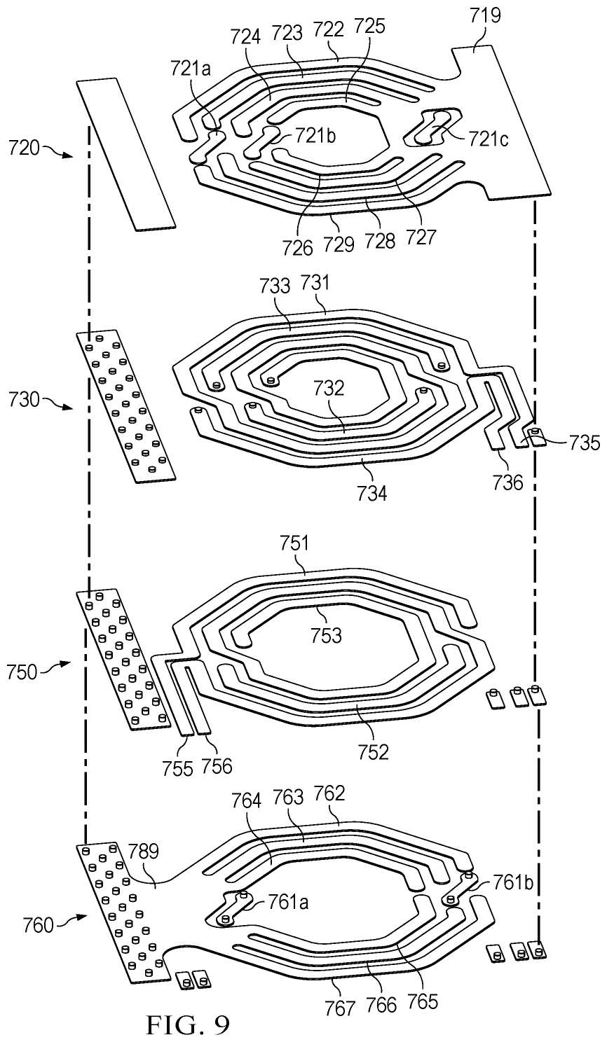

FIG. 8 shows a perspective view of the transformer 720, and FIG. 9 is an exploded view of the transformer better illustrating layers 720, 730, 750, and 760. Layer 720 includes a conductive pad 719 from which conductive segments 722, 723, 724, 725, 726, 727, 728, and 729 extend and wrap around towards the opposite side of the transformer. Layer 720 also includes bridge 721a, 721b, and 721c which couple together respective conductive segments within layer 730. Layer 730 includes conductive segments 731, 732, 733, and 734 which, when coupled together by way of bridges 721a, 721b, and 721c (and associated vias 777, FIG. 7)), form one of the windings of the transformer. Conductive segments 731 and 734 provide terminals 735 and 736, respectively, of the winding.

Similarly, layer 760 includes a conductive pad 789 from which conductive segments 762, 763, 764, 765, 766, and 767 extend and wrap around towards the opposite side of the transformer. Layer 720 also includes bridge 761a and 761b which couple together respective conductive segments within layer 750. Layer 750 includes conductive segments 751, 752, and 753 which, when coupled together by way of bridges 761a and 761b (and associated vias 787 (FIG. 7)), form the other of the windings of the transformer. Conductive segments 751 and 753 provide terminals 755 and 756, respectively, of the winding.

In the embodiment of FIGS. 3-5, the layers of the transformer 120 are arranged as winding—shield/heat sink—winding—shield/heat sink (with the shield/heat sink layers including the bridges of the winding layers). In the embodiment of FIGS. 7-9, the layers 720 and 760 providing the shielding and heat sinks are on opposite sides of the stack of layers 730-750 and thus the arrangement of layers is shield/heat sink—winding—winding—shield/heat sink, with a thick dielectric layer 740 between the two inner winding layers 730 and 740.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

While the use of particular transistors is described herein, other transistors (or equivalent devices) may be used instead. For example, a p-channel field effect transistor (“PFET”) may be used in place of an n-channel field effect transistors (NFET) with little or no changes to the circuit. Furthermore, other types of transistors may be used (such as bipolar junction transistors (BJTs)).

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately,” or “substantially” preceding a parameter means +/−10 percent of the stated parameter.

Modifications are possible in the described embodiments, and other embodiments are possible, within the scope of the claims.

What is claimed is:

1. An apparatus, comprising:
a substrate;
a first conductive layer on the substrate, the first conductive layer including a first electromagnetic interference (EMI) shield;
a second conductive layer over the first conductive layer opposite the substrate, the second conductive layer comprising a first winding of a transformer;
a third conductive layer over the second conductive layer opposite the first conductive layer, the third conductive layer including a second EMI shield; and
a fourth conductive layer over the third conductive layer opposite the second conductive layer, the fourth conductive layer comprising a second winding of the transformer.

2. The apparatus of claim 1, wherein:
the first conductive layer includes a first set of conductive segments and a second set of conductive segments;
the first set of conductive segments comprises the first EMI shield; and
the second set of conductive segments is coupled to the second conductive layer by vias, and the second set of conductive segments is part of the first winding.

3. The apparatus of claim 2, wherein:
the third conductive layer includes a third set of conductive segments and a fourth set of conductive segments;
the third set of conductive segments comprises the second EMI shield; and
the fourth set of conductive segments is coupled to the fourth conductive layer by vias, and the fourth set of conductive segments is part of the second winding.

4. The apparatus of claim 3, wherein:
the first set of conductive segments is not coupled to the second set of conductive segments; and
the third set of conductive segments is not coupled to the fourth set of conductive segments.

5. The apparatus of claim 1, wherein the first EMI shield is configured to transfer heat from the first winding, and the second EMI shield is configured to transfer heat from the second winding.

6. The apparatus of claim 1, wherein:
the first winding has a first pair of terminals;
the second winding has a second pair of terminals; and
the first pair of terminals is on an opposite side of the transformer from the second pair of terminals.

7. The apparatus of claim 1, further comprising:
a first semiconductor die including a primary-side power stage, the primary-side power stage configured to convert an input voltage to a switching waveform, and the first semiconductor die coupled to the first winding of the transformer; and
a second semiconductor die coupled to the second winding of the transformer, the second semiconductor die including a rectifier.

8. An apparatus, comprising:
a substrate;
a first conductive layer on the substrate, the first conductive layer including a first electromagnetic interference (EMI) shield;
a second conductive layer over the first conductive layer opposite the substrate, the second conductive layer comprising a first winding of a transformer;
a third conductive layer over the second conductive layer opposite the first conductive layer, the third conductive layer comprising a second winding of the transformer; and
a fourth conductive layer over the third conductive layer opposite the second conductive layer, the fourth conductive layer including a second EMI shield.

9. The apparatus of claim 8, further comprising a dielectric layer between the second conductive layer and the third conductive layer.

10. The apparatus of claim 9, wherein a thickness of the dielectric layer is approximately 35 microns.

11. The apparatus of claim 8, wherein:
the first conductive layer includes a first set of conductive segments and a second set of conductive segments;
the first set of conductive segments comprises the first EMI shield; and
the second set of conductive segments is coupled to the second conductive layer by vias, and the second set of conductive segments is part of the first winding.

12. The apparatus of claim 11, wherein:
the fourth conductive layer includes a third set of conductive segments and a fourth set of conductive segments;
the third set of conductive segments comprises the second EMI shield; and
the fourth set of conductive segments is coupled to the third conductive layer by vias, and the fourth set of conductive segments is part of the second winding.

13. The apparatus of claim 12, wherein:
the first set of conductive segments is not coupled to the second set of conductive segments; and
the third set of conductive segments is not coupled to the fourth set of conductive segments.

14. The apparatus of claim 8, wherein the first EMI shield is configured to transfer heat from the first winding, and the second EMI shield is configured to transfer heat from the second winding.

15. The apparatus of claim 8, wherein:
the first winding has a first pair of terminals;
the second winding has a second pair of terminals; and
the first pair of terminals is on an opposite side of the transformer from the second pair of terminals.

16. The apparatus of claim 8, further comprising:
a first semiconductor die including a primary-side power stage, the primary-side power stage configured to convert an input voltage to a switching waveform, and the first semiconductor die coupled to the first winding of the transformer; and
a second semiconductor die coupled to the second winding of the transformer, the second semiconductor die including a rectifier.

17. An apparatus, comprising:
a substrate;
a first conductive layer on the substrate, the first conductive layer including a first electromagnetic interference (EMI) shield;
a second conductive layer over the first conductive layer opposite the substrate, the second conductive layer comprising a first winding of a transformer, wherein the first EMI shield is configured to transfer heat from the first winding;
a third conductive layer over the second conductive layer opposite the first conductive layer, the third conductive layer including a second EMI shield; and
a fourth conductive layer over the third conductive layer opposite the second conductive layer, the fourth conductive layer comprising a second winding of the transformer, wherein the second EMI shield is configured to transfer heat from the second winding.

18. The apparatus of claim 17, wherein:
the first conductive layer includes a first set of conductive segments and a second set of conductive segments;
the first set of conductive segments comprises the first EMI shield; and
the second set of conductive segments is coupled to the second conductive layer by vias, and the second set of conductive segments is part of the first winding.

19. The apparatus of claim 18, wherein:
the third conductive layer includes a third set of conductive segments and a fourth set of conductive segments;
the third set of conductive segments comprises the second EMI shield; and
the fourth set of conductive segments is coupled to the fourth conductive layer by vias, and the fourth set of conductive segments is part of the second winding.

20. The apparatus of claim 19, wherein:
the first set of conductive segments is not coupled to the second set of conductive segments; and
the third set of conductive segments is not coupled to the fourth set of conductive segments.
